(19) United States
(12) Patent Application Publication
(10) Pub. No.: US 2015/0064402 A1
(43) Pub. Date: Mar. 5, 2015

(54) RELEASE FILM FOR PRODUCING GREEN SHEET

(71) Applicant: LINTEC CORPORATION, Tokyo (JP)

(72) Inventors: Tomomi Fukaya, Tokyo (JP); Shinya Ichikawa, Tokyo (JP)

(21) Appl. No.: 14/389,348

(22) PCT Filed: Mar. 14, 2013
(86) PCT No.: PCT/JP2013/057180

§ 371 Date: Sep. 29, 2014

(30) Foreign Application Priority Data
Mar. 30, 2012 (JP) 2012-0083081

(51) Int. Cl. B28B 7/36

(52) U.S. Cl. CPC B28B 7/364
USPC 428/141

(57) ABSTRACT

A release film for producing a green sheet of the present invention includes a base material having a first surface and a second surface and a release agent layer formed at a side of the first surface of the base material. A maximum projection height Rp₂ of the second surface of the base material is in the range of 60 to 500 nm. An area occupation ratio of projections having a height of 60 nm or higher in the second surface is 10% or less. According to the present invention, it is possible to prevent pinholes and variation in partially thickness from occurring to the green sheet.

### TECHNICAL FIELD

The present invention relates to a release film for producing a green sheet.

### RELATED ART

When manufacturing a multilayer ceramic capacitor, a release film for producing a green sheet is used to form the green sheet.

The release film for producing the green sheet is usually composed of a base material and a release agent layer. The green sheet is manufactured by coating a ceramic slurry, in which ceramic particles and a binder resin are dispersed and dissolved in an organic solvent, on the release film for producing the green sheet and drying the coated ceramic slurry. By this method, it is possible to efficiently manufacture the green sheet having a uniform thickness. The green sheet thus manufactured is released from the release film for producing the green sheet and is used in manufacturing the multilayer ceramic capacitor.

During the manufacture of the green sheet as described above, the release film for producing the green sheet on which the green sheet is formed is usually stored and transported in a rolled state.

In the prior art, there has been made an attempt by which, in the release film for producing the green sheet as described above, a surface roughness (average roughness) of a surface (rear surface) of the base material opposite to a surface on which the release agent layer is formed is kept relatively high to prevent a problem of sticking (blocking) of front and rear surfaces of the release film for producing the green sheet stored in the rolled state (see, e.g., Patent Document 1).

However, in case of using the release film disclosed in Patent Document 1, it is sometimes a case that, when the release film for producing the green sheet provided with the green sheet is stored in the rolled state, a relatively rough surface shape of the rear surface of the release film for producing the green sheet is transferred to the green sheet and therefore the green sheet is partially made thin. As a result, when the capacitor is manufactured by laminating the green sheet, there may be a case where a defect is generated by short circuit.

On the other hand, if the surface roughness (average roughness) of the surface of the base material opposite to the surface on which the release agent layer is formed is made relatively low, the surface becomes too smooth and a sliding property of each front and rear surface of the release film for producing the green sheet grows poor. For that reason, there may be a case where a defect such as poor winding or blocking occurs.
The Patent Document 1 is JP-A 2003-203822

### SUMMARY OF THE INVENTION

It is an object of the present invention to provide a release film for producing a green sheet having a specific surface shape, which is capable of preventing partial thickness variation from generating in a green sheet. Specifically, it is the object of the present invention to provide a release film for producing a green sheet having the specific surface shape, which is capable of preventing a defect from generating by transferring a surface shape of a rear surface of the release film for producing the green sheet to the green sheet.

The above object is achieved by the inventions (1) to (5) set forth below.

(1) A release film for producing a green sheet, comprising:

a base material having a first surface and a second surface; and

a release agent layer provided at a side of the first surface of the base material,

wherein a maximum projection height Rp₂ of the second surface of the base material is in the range of 60 to 500 nm and an area occupation ratio of projections having a height of 60 nm or higher in the second surface is 10% or less.

(2) In the release film for producing the green sheet described in the above-mentioned invention (1), an arithmetic average roughness Ra₁ of an outer surface of the release agent layer is 8 nm or less and a maximum projection height Rp₁ of the outer surface is 50 nm or less.

(3) In the release film for producing the green sheet described in the above-mentioned invention (1) or (2), an area occupation ratio of projections having a height of 10 nm or higher in the outer surface of the release agent layer is 10% or less.

(4) In the release film for producing the green sheet described in the above-mentioned inventions (1) to (3), an arithmetic average roughness Ra₂ of the second surface of the base material is in the range of 5 to 40 nm.

(5) In the release film for producing the green sheet described in the above-mentioned inventions (1) to (4), the base material is formed into a laminated body having laminated layers, and at least one of the laminated layers is an antistatic layer.

According to the present invention, it becomes possible to prevent the generation of the partial thickness variation in the green sheet.

### BRIEF DESCRIPTION OF THE DRAWINGS

FIG. 1 is a cross sectional view of a release film for producing a green sheet according to the present invention.

### DETAILED DESCRIPTION OF THE PREFERRED EMBODIMENTS

Hereinafter, the present invention will be described in detail based on a preferred embodiment.

<<Release Film for Producing Green Sheet>>

A release film for producing a green sheet according to the present invention is used in manufacturing a green sheet.

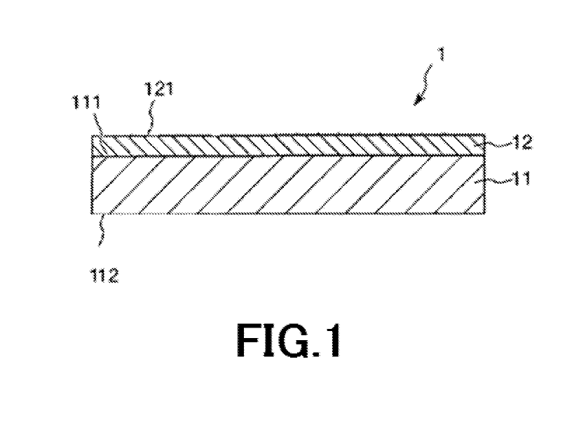

FIG. 1 is a cross sectional view of a release film 1 for producing a green sheet according to the present invention.

As shown in FIG. 1, the release film 1 for producing the green sheet includes a base material 11 having a first surface 111 and a second surface 112, and a release agent layer 12 formed on the first surface 111 of the base material 11.

The release film for producing the green sheet according to the present invention is characterized by including the base material and the release agent layer provided at the side of the first surface of the base material, wherein a maximum projection height Rp₂ of the second surface of the base material is in the range of 60 to 500 nm and an area occupation ratio of projections having a height of 60 nm or higher in the second surface is 10% or less.

Use of the release film for producing the green sheet of the present invention having the aforementioned features makes it possible to prevent the generation of the partial thickness variation in the green sheet. As a result, it becomes possible to form a high-quality green sheet. In particular, even if the green sheet has an extremely small thickness (e.g., a thickness of 5 μm or less, particularly a thickness of from 0.5 μm to 2 μm), it is possible to form a high-quality green sheet which is free from the aforementioned defects.

Detailed description will now be made on respective layers that constitute the release film 1 for producing the green sheet according to the present embodiment.

<Base Material>

The base material 11 includes the first surface 111 and the second surface 112.

The base material 11 serves to apply physical strength, such as rigidity or flexibility, to the release film 1 for producing the green sheet.

The base material 11 is not particularly limited. An arbitrary one of the materials well-known in the art can be suitably selected and used as the base material 11. Examples of the base material 11 may include a film made of a plastic, e.g., polyester such as polyethyleneterephthalate or polyethylenenaphthalate, polyolefin such as polypropylene or polymethylpentene, or polycarbonate. The base material 11 may be a monolayer or may be multiple layers including two or more layers of the same kind or different kinds. Among them, a polyester film is preferred. A polyethyleneterephthalate film is particularly preferred. A biaxially-stretched polyethyleneterephthalate film is more preferred. The film made of the plastic seldom generates dust or the like during the processing, use thereof or the like. It is therefore possible to effectively prevent generation of a coating defect of a ceramic slurry by the dust or the like.

As set forth above, the maximum projection height Rp₂ of the second surface 112 of the base material 11 is in the range of 60 to 500 nm. In this case, when the release film 1 for producing the green sheet, in which the outer surface 121 of the release agent layer 12 is highly smooth, is wound around a paper-made, plastic-made, metal-made core member or the like in the roll shape, an air is removed well. This makes it possible to effectively suppress winding deviation. For that reason, there is no need to increase winding tension. It is therefore possible to suppress deformation of the release film 1 for producing the green sheet, which is wound around a winding core, caused by the winding tension. Furthermore, it is possible to prevent the generation of blocking between the front and rear surfaces of the release film 1 for producing the green sheet wound in the roll shape. Moreover, when the release film 1 for producing the green sheet provided with the green sheet is stored in an wound state, it is possible to prevent the surface shape of the second surface 112 of the base material 11 to be closely contacted with the green sheet from being transferred to the green sheet. It is also possible to prevent the generation of the pinhole and the partial thickness variation in the green sheet. As a result, it becomes possible to form the high-quality green sheet.

In contrast, if the maximum projection height Rp₂ is less than the lower limit value, when the release film 1 for producing the green sheet not yet provided with the green sheet is wound to store the same, the air is easily trapped and the winding deviation is easy to occur. As a result, it becomes difficult to handle the release film 1 for producing the green sheet. Further, the front and rear surfaces (the second surface 112 of the base material 11 and the outer surface 121 of the release agent layer 12) of the release film 1 for producing the green sheet wound in the roll shape closely contact with each other. This makes it difficult to sufficiently prevent the generation of the blocking. On the other hand, if the maximum projection height Rp₂ exceeds the upper limit value, when winding the release film 1 for producing the green sheet provided with the green sheet, a shape of projection of the second surface 112 of the base material 11 to be closely contacted with the green sheet is transferred to the green sheet. For that reason, there is a fear that the pinhole or the partial thickness variation is generated in the green sheet. This makes it difficult to sufficiently maintain smoothness of the green sheet.

As mentioned above, the maximum projection height Rp₂ of the second surface 112 of the base material 11 is in the range of 60 to 500 nm. It is more preferred that the maximum projection height Rp₂ is in the range of to 400 nm. It is particularly preferred that the maximum projection height Rp₂ is 100 to 300 nm. In this case, the aforementioned effects become more remarkable.

The area occupation ratio of projections having the height of 60 nm or higher in the second surface 112 of the base material 11 is 10% or less. In a case where the area occupation ratio of the projections having the height of 60 nm or higher is large, the case becomes an index which indicates that the projections having the height of nm or higher are densely-distributed in the second surface 112 or the projections are high. In the case, when the release film 1 for producing the green sheet provided with the green sheet is stored in the wound state, it is possible to prevent the surface shape of the second surface 112 of the base material 11 to be closely contacted with the green sheet from being transferred to the green sheet. It is also possible to prevent the generation of the pinhole and the partial thickness variation in the green sheet. As a result, it becomes possible to form the high-quality green sheet.

In contrast, if the area occupation ratio of the projections having the height of 60 nm or higher in the second surface 112 of the base material 11 exceeds the upper limit value, when winding the release film 1 for producing the green sheet provided with the green sheet, the shape of projection (shape of particularly high projection) of the second surface 112 of the base material to be closely contacted with the green sheet is transferred to the green sheet. For that reason, there is a fear that the pinhole or the partial thickness large variation is generated in the green sheet. This makes it difficult to sufficiently maintain the smoothness of the green sheet.

As mentioned above, the area occupation ratio of the projections having the height of 60 nm or higher in the second surface 112 of the base material 11 is 10% or less. It is more preferred that the area occupation ratio of the projections having the height of 60 nm or higher in the second surface 112 of the base material 11 is 7% or less. In this case, the aforementioned effects become more remarkable.

It is preferred that the arithmetic average roughness Ra₂ of the second surface 112 of the base material 11 is in the range of 5 to 40 nm. It is more preferred that the arithmetic average roughness Ra₂ of the second surface 112 of the base material 11 is in the range of 10 to 30 nm. In the case, it is possible to prevent the generation of the pinhole and the partial thickness variation in the green sheet. Further, it is possible to effectively suppress the winding deviation when the release film 1 for producing the green sheet is wound in the core member. For that reason, there is no need to increase the winding tension. It is therefore possible to suppress the deformation of the release film 1 for producing the green sheet, which is wound around the winding core, caused by the winding tension.

A maximum projection height Rp₀ of the first surface 111 of the base material 11 is preferably in the range of 10 to 700 nm and more preferably in the range of 20 to 500 nm. As will be described later, a smoothened release agent layer 12 that fills spaces of depressed parts and slant surfaces of raised parts of the first surface 111 of the base material 11 is formed on the first surface 111 of the base material 11. Therefore, if the maximum projection height Rp₀ is set to fall within the above range, a smoothening action becomes particularly remarkable.

An arithmetic average roughness Ra₀ of the first surface 111 of the base material 11 is preferably in the range of 2 to 80 nm and more preferably in the range of 5 to 50 nm. As will be described later, the smoothened release agent layer 12 that fills the spaces of the depressed parts and the slant surfaces of the raised parts of the first surface 111 of the base material 11 is formed on the first surface 111 of the base material 11. Therefore, if the arithmetic average roughness Ra₀ is set to fall within the above range, the smoothening action becomes particularly remarkable.

An average thickness of the base material 11 is preferably in the range of 10 to 300 μm and more preferably in the range of 15 to 200 μm. In this case, resistance to tear or breaking can be made particularly superior while keeping the proper flexibility of the release film 1 for producing the green sheet.

<Release Agent Layer>

The release agent layer 12 is formed on the first surface 111 of the base material 11.

The release agent layer 12 serves to apply releasability to the release film 1 for producing the green sheet.

The release agent layer 12 is not particularly limited. A release agent layer, which has been used as the release agent layer for the release film for producing the green sheet in the prior art, can be used without limitation. Examples of a release-agent-layer-forming material for forming the release agent layer 12 may include a thermosetting material, an active energy ray curing material and the like.

Examples of active energy rays may include an electromagnetic wave such as infrared light, visible light, ultraviolet rays, and X-rays, and a particle beam such as an electron beam, an ion beam, neutron rays and alpha rays. Among them, the ultraviolet rays are preferred. This makes it possible to form the release agent layer 12 easily and reliably.

It is preferred that the active energy ray curing material as the release-agent-layer-forming material is a release-agent-layer-forming material which includes an active energy ray curable compound (A) having a reactive functional group selected from a (meth)acryloyl group, an alkenyl group and a maleimide group, and a polyorganosiloxane (B).

In the release agent layer 12 formed of such a release-agent-layer-forming material, a component being derived from the polyorganosiloxane (B) is in a state of segregation near the outer surface 121 of the release agent layer 12. The reason for occurrence of this segregation is presumed to be that, due to the use of the polyorganosiloxane (B) differing in a molecular structure, polarity and a molecular weight from the active energy ray curable compound (A), the polyorganosiloxane (B) is pushed up toward the outer surface 121 while a coated layer of the release-agent-layer-forming material is cured.

The respective components of the release-agent-layer-forming material will now be described in detail.

[Active Energy Ray Curable Compound (A)]

The active energy ray curable compound (A) is a component that makes contribution to the formation of the release agent layer 12 by curing.

It is preferred that the active energy ray curable compound (A) has the reactive functional group selected from the (meth)acryloyl group, the alkenyl group and the maleimide group.

It is preferred that the active energy ray curable compound (A) has, in one molecule, the three or more reactive functional groups selected from the (meth)acryloyl group, the alkenyl group and the maleimide group from the aspect of curability. Thus, even if the release agent layer 12 has a thickness at which the curability is hardly obtainable due to an oxygen inhibition, it is possible to obtain superior curability, superior solvent resistance and superior releasability. Examples of the alkenyl group may include a group having a carbon number of 2 to 10 such as a vinyl group, an allyl group, a propenyl group and a hexenyl group.

In the active energy ray curable compound (A), a content of the reactive functional groups selected from the (meth)acryloyl group, the alkenyl group and the maleimide group is preferably an equivalent of 10 or more per 1 kg of the active energy ray curable compound (A). In this case, even when the release-agent-layer-forming material is coated as a thin film on the first surface 111, it is possible to keep particularly the superior curability of the active energy ray curable compound (A).

Specific examples of the active energy curable compound (A) may include a multifunctional (meth)acrylate such as dipentaerythritol tri(meth)acrylate, dipentaerythritol tetra(meth)acrylate, dipentaerythritol penta(meth)acrylate, dipentaerythritol hexa(meth)acrylate, pentaerythritol tri(meth)acrylate and pentaerythritol tetra(meth)acrylate. Among them, it is preferable to use at least one multifunctional acrylate selected from the group consisting of dipentaerythritol triacrylate, dipentaerythritol tetraacrylate, dipentaerythritol pentaacrylate, dipentaerythritol hexaacrylate, pentaerythritol triacrylate, and pentaerythritol tetraacrylate. In this case, even when the release-agent-layer-forming material is coated as the thin film on the first surface 111, it is possible to keep particularly the superior curability of the active energy ray curable compound (A).

A solid component content (content ratio in the total solid components except a solvent) of the active energy ray curable compound (A) in the release-agent-layer-forming material is preferably in the range of 65 to 98.5 mass % and more preferably in the range of 71 to 94 mass %.

[Polyorganosiloxane (B)]

The polyorganosiloxane (B) is a component for developing the releasability in the release agent layer 12.

Examples of the polyorganosiloxane (B) may include the polyorganosiloxane having a straight or branched molecular chain. Particularly, it is preferable to use a denatured polyorganosiloxane in which at least one reactive functional group selected from the group consisting of a (meth)acryloyl group, an alkenyl group and a maleimide group is bonded, at one or both of terminals of the molecular chain and a side chain of the molecular chain, to silicon atoms of the molecular chain, either directly or through a bivalent linking group. Examples of the alkenyl group may include a group having a carbon number of 2 to 10 such as a vinyl group, an allyl group, a propenyl group and a hexenyl group. Examples of the bivalent linking group may include an alkylene group, an alkyleneoxy group, an oxy group, an imino group, a carbonyl group and the combinations thereof. The carbon number of the bivalent linking group is preferably in the range of 1 to 30 and more preferably in the range of 1 to 10. Depending on the necessity, two or more kinds of substances may be combined and used as the polyorganosiloxane (B).

The denatured polyorganosiloxane substituted by the reactive functional group is incorporated into and fixed to a cross-linking structure of a cured body of the active energy ray curable compound (A) when the active energy ray curable compound (A) is cured by the irradiation of the active energy rays. This makes it possible to prevent the polyorganosiloxane as one component of the release agent layer 12 from migrating to and transferring to the green sheet formed on the outer surface 121 of the release agent layer 12.

Examples of an organic group other than the reactive functional group that constitutes the polyorganosiloxane (B) may include a monovalent hydrocarbon group that does not have an aliphatic unsaturated bond. The organic group may be a plurality of monovalent hydrocarbon groups in which the groups may be the same kind or different kinds. The carbon number of the hydrocarbon group is preferably in the range of 1 to 12 and more preferably in the range of 1 to 10. Specific examples of the hydrocarbon group may include an alkyl group such as a methyl group, an ethyl group or a propyl group, and an aryl group such as a phenyl group or a tolyl group.

Particularly, it is preferred that 80 mol % or more of the organic group other than the reactive functional group that constitutes the polyorganosiloxane (B) is the methyl group. In this case, the releasability of the release agent layer 12 can be kept particularly superior.

A solid component content of the polyorganosiloxane (B) in the release-agent-layer-forming material is preferably in the range of 0.5 to 5 mass % and more preferably in the range of 0.7 to 4 mass %. In this case, the ceramic slurry can be coated on the base material 11 without repelling the ceramic slurry. This makes it possible to keep particularly the superior releasability of the release film 1 for producing the green sheet.

In contrast, if the solid component content of the polyorganosiloxane (B) in the release-agent-layer-forming material is less than the lower limit value, there is a fear that the release agent layer 12 thus formed cannot show sufficient releasability. On the other hand, if the solid component content of the polyorganosiloxane (B) in the release-agent-layer-forming material exceeds the upper limit value, there is a fear that, when the ceramic slurry is coated on the outer surface 121 of the release agent layer 12, the ceramic slurry is repelled with ease. Furthermore, there is sometimes a case that the release agent layer 12 is hardly cured and sufficient releasability is not obtained.

Assuming that a blending amount of the active energy ray curable compound (A) is A mass parts and a blending amount of the polyorganosiloxane (B) is B mass parts, a mass ratio B/A is preferably in the range of 0.7/99.3 to 5/95 and more preferably in the range of 1/99 to 4.5/95.5. In this case, the aforementioned effects become more remarkable.

[Photopolymerization Initiator (C)]

In case where the ultraviolet rays are used as the active energy rays for curing the release-agent-layer-forming material, the release-agent-layer-forming material may include a photopolymerization initiator (C).

The photopolymerization initiator (C) is not particularly limited. For example, it is preferable to use an α-aminoalkylphenone-based photopolymerization initiator. Such an α-aminoalkylphenone-based photopolymerization initiator is a compound which makes the release-agent-layer-forming material be less susceptible to the oxygen inhibition when curing. Thus, the superior curability can be obtained even if the release film for producing the green sheet is manufactured under an air atmosphere.

Examples of the α-aminoalkylphenone-based photopolymerization initiator may include 2-methyl-1-[4-(methylthio)phenyl]-2-morpholinopropane-1-one, 2-benzyl-2-dimethylamino-1-(4-morpholinophenyl)-butanone-1, and 2-(dimethylamino)-2-[(4-methylphenyl)methyl]-1-[4-(4-morpholinyl)phenyl]-1-butanone. In this case, it is possible to obtain the superior curability, the superior solvent resistance and the superior releasability.

A solid component content of the photopolymerization initiator (C) in the release-agent-layer-forming material is preferably in the range of 1 to 20 mass % and more preferably in the range of 3 to 15 mass %. In this case, even if the release agent layer 12 has the thickness at which curability is hardly obtainable due to the oxygen inhibition, it is possible to obtain the superior curability, the superior solvent resistance and the superior releasability.

The release-agent-layer-forming material may contain other components than the aforementioned components. For instance, the release-agent-layer-forming material may contain a sensitizer, an antistatic agent, a hardening agent, a reactive monomer, and so forth.

As the sensitizer, it may be possible to use, e.g., 2,4-diethyl thioxanthone or isopropyl thioxanthone. This makes it possible to enhance reactivity.

A solid component content of other components in the release-agent-layer-forming material is preferably in the range of 0 to 10 mass %.

An average thickness of the release agent layer 12 is preferably in the range of 0.3 to 2 μm. If the average thickness of the release agent layer 12 is less than the lower limit value, the smoothness of the outer surface 121 of the release agent layer 12 becomes insufficient. As a result, there is a fear that, when the green sheet is molded on the outer surface 121 of the release agent layer 12, the pinhole or the partial thickness variation is generated in the green sheet. On the other hand, if the average thickness of the release agent layer 12 exceeds the upper limit value, a curl is easily generated in the release film 1 for producing the green sheet due to shrinkage by curing the release agent layer 12. Furthermore, the blocking is easily generated between the front and rear surfaces of the wound release film 1 for producing the green sheet (between the second surface 112 of the base material 11 and the outer surface of the release agent layer 12). For that reason, there is a fear that a trouble is generated in unwinding the release film 1 for producing the green sheet or that an electric charge amount is increased when unwinding the release film 1 for producing the green sheet.

It is preferable that the arithmetic average roughness Ra₁ of the outer surface 121 of the release agent layer 12 is 8 nm or less. By setting the outer surface 121 of the release agent layer 12 to be smoother than the second surface 112 of the base material 11 in this way, it is possible to prevent the pinhole from being formed in the green sheet by generating a region where a depression (depressed part) of the green sheet which may be formed by projections of the outer surface 121 of the release agent layer 12 coincides with a depression (depressed part) of the green sheet which may be formed by the projections of the second surface 112 of the base material 11. Further, when the green sheet is molded on the outer surface 121 of the release agent layer 12, it is possible to reliably prevent the generation of the pinhole and the partial thickness variation in the green sheet. This makes it possible to keep highly smooth the surface of the green sheet which is in contact with the outer surface 121 of the release agent layer 12.

It is preferable that the maximum projection height Rp₁ of the outer surface 121 of the release agent layer 12 is 50 nm or less. By setting the outer surface 121 of the release agent layer 12 to be smoother than the second surface 112 of the base material 11 in this way, it is possible to prevent the pinhole from being formed in the green sheet by generating a region where the depression of the green sheet which may be formed by the projections of the outer surface 121 of the release agent layer 12 coincides with the depression of the green sheet which may be formed by the projections of the second surface 112 of the base material 11. Further, when the green sheet is molded on the outer surface 121 of the release agent layer 12, it is possible to reliably prevent the generation of the pinhole and the partial thickness variation in the green sheet. This makes it possible to keep highly smooth the surface of the green sheet which is in contact with the outer surface 121 of the release agent layer 12.

It is preferable that the area occupation ratio of the projections having the height of 10 nm or higher in the outer surface 121 of the release agent layer 12 is 10% or less. Thus, when the green sheet is molded on the outer surface 121 of the release agent layer 12, it is possible to reliably prevent the generation of the pinhole and the partial thickness variation in the green sheet. This makes it possible to keep highly smooth the surface of the green sheet which is in contact with the outer surface 121 of the release agent layer 12.

<<Method of Producing Release Film for Producing Green Sheet>>

Next, description will be made on one preferred embodiment of a method of producing the release film 1 for producing the green sheet described above.

The method of the present embodiment includes a first step for preparing the base material 11, a second step for preparing the release-agent-layer-forming material, and a third step for forming the release agent layer 12 by coating the release-agent-layer-forming material on the first surface 111 of the base material 11 and drying the release-agent-layer-forming material to form a coated layer, and then irradiating the active energy rays to the coated layer and curing the coated layer.

The respective steps will now be described in detail.

<First Step>

First, the base material 11 is prepared.

The first surface 111 of the base material 11 can be subjected to a surface treatment using an oxidation method and the like. This makes it possible to keep superior adhesion of the base material 11 and the release agent layer 12 provided on the first surface 111 of the base material 11.

Examples of the oxidation method may include a corona discharge treatment, a plasma discharge treatment, a chromium oxidation treatment (wet-type), a flame treatment, a hot air treatment, an ozone treatment and an ultraviolet irradiation treatment. These surface treatment methods are properly selected depending on the kind of the base material 11. The corona discharge treatment method is preferred from the aspect of the effect and operability.

<Second Step>

Next, the release-agent-layer-forming material is obtained by dissolving or dispersing such components as the active energy ray curable compound (A) and the polyorganosiloxane (B) in a solvent.

Examples of the solvent may include methanol, ethanol, toluene, ethyl acetate, xylene, methyl ethyl ketone, methyl butyl ketone, isopropyl alcohol and the like.

<Third Step>

Next, the coated layer is obtained by coating the release-agent-layer-forming material on the first surface 111 of the base material 11 and drying the release-agent-layer-forming material. Between the coating process and the drying process, the release-agent-layer-forming material fills the spaces of depressed parts and the slant surfaces of raised parts of the first surface 111, thereby forming a smoothened coated layer. In case where the release-agent-layer-forming material is the thermosetting material, the smoothened release agent layer 12 is formed by curing the coated layer by heat during the drying process. In case where the release-agent-layer-forming material is the active energy ray curing material, the smoothened release agent layer 12 is formed by irradiating the active energy rays to the coated layer thus obtained and curing the coated layer. In case where the active energy rays are the ultraviolet rays, the irradiation amount thereof is set such that an accumulated amount of light is preferably in the range of 50 to 1000 mJ/cm² and more preferably in the range of 100 to 500 mJ/cm². In case where the active energy rays are the electron beam, the irradiation amount of the electron beam is preferably in the range of 0.1 to 50 kGy approximately.

Thus, the release film 1 for producing the green sheet is obtained.

Examples of a coating method of the release-agent-layer-forming material may include a gravure coating method, a bar coating method, a spray coating method, a spin coating method, a knife coating method, a roll coating method, a die coating method and the like.

According to the steps described above, it is possible to easily produce the release film 1 for producing the green sheet that can be used in manufacturing the green sheet which is suppressed the generation of the pinhole and the partial thickness variation thereof.

While the present invention has been described in detail based on the preferred embodiment, the present invention is not limited to the aforementioned embodiment.

For example, in the aforementioned embodiment, the base material 11 has been described as being formed of a single layer. However, the present invention is not limited thereto. For instance, the base material 11 may not be formed of the single layer but may be formed of the laminated body having two or more layers. In case where the base material 11 is the laminated body, for example, an outermost one of laminated layers, which adjoins the release agent layer 12, may serve as a layer that enhances adhesion.

Furthermore, for example, at least one of laminated layers may serve as the antistatic layer. Specific examples of the base material 11 may include a laminated body of the plastic-made film and the antistatic layer. The antistatic layer of the base material 11 formed of the laminated body may be positioned at a same side as the release agent layer 12 of the release film 1 for producing the green sheet or may be positioned at an opposite side of the release film 1 for producing the green sheet from the release agent layer 12. Use of the base material 11 formed of the laminated body having the antistatic layer makes it possible to effectively prevent electrification when unwinding the release film 1 for producing the green sheet not yet provided with the green sheet.

It is preferable that the antistatic layer is, e.g., a resin layer composed of an antistatic-layer-forming composition which contains a conductive polymer and a resin. An arbitrary one selected from the conductive polymers well-known in the art can be used as the conductive polymer. Among them, it is preferable to use a polythiophene-based conductive polymer, a polyaniline-based conductive polymer or a polypyrrole-based conductive polymer. Examples of the polythiophene-based conductive polymer may include polythiophene, poly(3-alkylthiophene), poly(3-thiophene-β-ethanesulfonic acid), and a mixture of polyalkylene dioxythiophene and polystyrene sulfonate. Examples of the polyalkylene dioxythiophene may include polyethylene dioxythiophene, polypropylene dioxythiophene, and poly(ethylene/propylene)dioxythiophene. Examples of the polyaniline-based conductive polymer may include polyaniline, polymethylaniline, and polymethoxyaniline. Examples of the polypyrrole-based conductive polymer may include polypyrrole, poly(3-methylpyrrole), and poly(3-octylpyrrole). These conductive polymer compounds may be used either independently or in combination of two or more kinds thereof. Furthermore, it is preferred that the resin used in the antistatic-layer-forming composition is mainly composed of at least one resin selected from the group consisting of a polyester resin, an urethane resin and an acryl resin. These resins may be a thermosetting compound or an ultraviolet curable compound.

A content of the conductive polymer in the antistatic-layer-forming composition is preferably in the range of 0.1 to 50 mass % and more preferably in the range of 0.3 to 30 mass % in terms of solid content conversion. If the content of the conductive polymer falls within the above range, a sufficient antistatic property is obtained and strength of the antistatic layer formed of the antistatic-layer-forming composition becomes sufficient.

A thickness of the antistatic layer is in the range of 30 to 290 nm and preferably in the range of 30 to 250 nm. If the thickness of the antistatic layer falls within the above range, a sufficient film formation property is obtained and a trouble such as repellence or the like is hard to occur.

A surface resistivity of the release agent layer 12 of the release film 1 for producing the green sheet that makes use of the base material 11 formed of the laminated body having the antistatic layer is preferably in the range of 1×10⁶ to 1×10¹²Ω/□ and more preferably in the range of 1×10⁷ to 1×10¹⁰Ω/□.

The method of producing the release film for producing the green sheet according to the present invention is not limited to the aforementioned method. If necessary, an arbitrary step may be added.

### EXAMPLES

Next, description will be made on specific examples of the release film for producing the green sheet according to the present invention.

[1] Production of Release Film for Producing Green Sheet

### Example 1

First, a biaxially-stretched polyethyleneterephthalate film [having a thickness of 31 μm, an arithmetic average roughness Ra₀ of a first surface of 29 nm, a maximum projection height Rp₀ of the first surface of 257 nm, an arithmetic average roughness Ra₂ of a second surface of 29 nm, and a maximum projection height Rp₂ of the second surface of 257 nm] was prepared as a base material.

Next, 94 mass parts of dipentaerythritol hexaacrylate [having a solid content of 100 mass %] as an active energy ray curable compound (A), 1 mass part of polydimethyl siloxane containing a polyether-modified acryloyl group [produced by BYK-Chemie GmbH and sold under a trade name “BYK-3500”, and having a solid content of 100 mass %] as a polyorganosiloxane (B), and 5 mass parts of an α-aminoalkylphenone-based photopolymerization initiator [2-methyl-1-[4-(methylthio)phenyl]-2-morpholinopropane-1-one produced by BASF Corporation and sold under a trade name “IRGACURE907”, and having a solid content of 100 mass %] as photopolymerization initiator (C), were diluted with a mixed solvent of isopropyl alcohol and methyl ethyl ketone (having a mass ratio of 3/1). Thus, a release-agent-layer-forming material having a solid content of 20 mass % was obtained.

The release-agent-layer-forming material thus obtained was coated on the first surface of the base material with a bar coater. The release-agent-layer-forming material was dried at 80° C. for one minute. And then, a release agent layer (having a thickness of 1 μm) was formed by irradiating ultraviolet rays to the release-agent-layer-forming material (in an accumulated amount of light of 250 mJ/cm²). Consequently, a release film for producing a green sheet was obtained.

### Example 2

A release film for producing a green sheet was produced in the same manner as in Example 1 except that the base material was changed to a biaxially-stretched polyethyleneterephthalate film [having a thickness of 31 μm, an arithmetic average roughness Ra₀ of a first surface of 15 nm, a maximum projection height Rp₀ of the first surface of 98 nm, an arithmetic average roughness Ra₂ of a second surface of 15 nm, and a maximum projection height Rp₂ of the second surface of 98 nm].

### Example 3

A release film for producing a green sheet was produced in the same manner as in Example 1 except that the base material was changed to a biaxially-stretched polyethyleneterephthalate film [having a thickness of 38 μm, an arithmetic average roughness Ra₀ of a first surface of 35 nm, a maximum projection height Rp₀ of the first surface of 471 nm, an arithmetic average roughness Ra₂ of a second surface of 35 nm, and a maximum projection height Rp₂ of the second surface of 471 nm].

### Example 4

A release film for producing a green sheet was produced in the same manner as in Example 1 except that the thickness of the release agent layer was changed to 0.5 μm.

### Example 5

A release film for producing a green sheet was produced in the same manner as in Example 1 except that the thickness of the release agent layer was changed to 1.9 μm.

### Example 6

First, an antistatic-layer-forming composition [in which a resin composition (produced by CHUKYO YUSHI CO., LTD. and sold under a trade name “P-973”, and having a solid content of 10 mass %) obtained by mixing in the range of 0.1 to 1.0 mass % of polyethylene dioxythiophene (PEDOT) and polystyrene sulfonate (PSS) as a conductive polymer with a mixed resin emulsion containing copolyester and polyurethane was diluted by a mixed liquid of isopropyl alcohol and purified water (having a mixture ratio of 1:1) so as to have a solid content of 1.0 mass %] was uniformly coated on a biaxially-stretched polyethyleneterephthalate film having a thickness of 31 μm such that, when dried, an antistatic layer has a thickness of 0.05 μm. The antistatic-layer-forming composition thus coated was dried at 120° C. for one minute. Thus, a base material [having a thickness of 31.05 μm, an arithmetic average roughness Ra₀ of a first surface (a surface existing at the same side as the antistatic layer) of 29 nm, a maximum projection height Rp₀ of the first surface (the surface existing at the same side as the antistatic layer) of 266 nm, an arithmetic average roughness Ra₂ of a second surface of 29 nm, and a maximum projection height Rp₂ of the second surface of 257 nm] formed of a laminated body of the biaxially-stretched polyethyleneterephthalate film having the thickness of 31 μm and the antistatic layer having the thickness of 0.05 μm was produced.

Next, a release-agent-layer-forming material was prepared in the same manner as in Example 1.

The release-agent-layer-forming material thus obtained was coated with a bar coater on the first surface of the base material formed of the laminated body. A coated layer was obtained by drying the release-agent-layer-forming material at 80° C. for one minute. A release agent layer (having a thickness of 1 μm) was formed by irradiating ultraviolet rays to the coated layer thus obtained (in an accumulated amount of light of 250 mJ/cm²). Consequently, a release film for producing a green sheet was obtained.

The release film for producing the green sheet thus obtained was cut into a size of 100 mm×100 mm and was humidity-controlled for 24 hours at a temperature of 23° C. and at a humidity of 50%. Thereafter, a resistivity of the surface existing at a side of the release agent layer was measured in accordance with JIS K6911 (1995) using “R12704 Resistivity Chamber” made by Advantest Corporation and “Digital Electrometer R8252” made by Advantest Corporation. As a result, it was found that the resistivity of the surface existing at the side of the release agent layer was 10⁹Ω/□.

The release film for producing the green sheet thus obtained was wound in a roll shape with a width of 400 mm and a length of 5000 m. The release film roll was unwound by a cutting machine at a speed of 100 m/min. An electric charge amount (unwinding electric charge amount) on the surface of the release agent layer of the just-unwound release film was measured using “Explosion-Proof Type Static Electricity Potential Measuring Device KSD-0108” made by KASUGA ELECTRIC WORKS LTD. As a result, it was found that the electric charge amount was 7 kV.

### Example 7

First, an antistatic-layer-forming composition [which was obtained by mixing 125 mass parts of a solution containing 75 mass parts of an acryl-based monomer containing dipentaerythritol hexaacrylate, pentaerythritol hexaacrylate and N-vinyl pyrrolidone in a mass ratio of 45:20:10, 20 mass parts of butyl acetate and 30 mass parts of isopropanol, 15.5 mass parts of an aqueous solution containing 1.3 mass % of polyethylene dioxythiophene/polystyrene sulfonate (PEDOT/PSS) as a conductive polymer, and 0.2 mass part of α-hydroxy cyclohexyl phenyl methanone as a photopolymerization initiator, and then diluting the mixture with isopropanol such that a sum amount of the acryl-based monomer and the conductive polymer became equal to 1 mass %] was uniformly coated with a Mayer bar on a biaxially-stretched polyethyleneterephthalate film having a thickness of 31 μm such that, when dried, an antistatic layer has a thickness of 0.05 μm. The antistatic-layer-forming composition was heated for one minute at 55° C. and was irradiated with ultraviolet rays (in an accumulated amount of light of 250 mJ/cm²). Thus, a base material [having a thickness of 31.05 μm, an arithmetic average roughness Ra₀ of a first surface of 29 nm, a maximum projection height Rp₀ of the first surface of 257 nm, an arithmetic average roughness Raₑ of a second surface (a surface existing at the side of the antistatic layer) of 28 nm, and a maximum projection height Rp₂ of the second surface (the surface existing at the side of the antistatic layer) of 263 nm] formed of a laminated body of the biaxially-stretched polyethyleneterephthalate film having the thickness of 31 μm and the antistatic layer having the thickness of 0.05 μm was produced.

Next, a release-agent-layer-forming material was prepared in the same manner as in Example 1.

The release-agent-layer-forming material thus obtained was coated with a bar coater on the first surface of the base material formed of the laminated body. A coated layer was obtained by drying the release-agent-layer-forming material at 80° C. for one minute. A release agent layer (having a thickness of 1 μm) was formed by irradiating the ultraviolet ray to the coated layer thus obtained (in an accumulated amount of light of 250 mJ/cm²). Consequently, a release film for producing a green sheet was obtained.

The release film for producing the green sheet thus obtained was cut into a size of 100 mm×100 mm and was humidity-controlled for 24 hours at a temperature of 23° C. and at a humidity of 50%. Thereafter, a resistivity of the surface existing at a side of the release agent layer was measured in accordance with JIS K6911 (1995) using “R12704 Resistivity Chamber” made by Advantest Corporation and “Digital Electrometer R8252” made by Advantest Corporation. As a result, it was found that the resistivity of the surface existing at the side of the release agent layer was 10⁹Ω/□.

The release film for producing the green sheet thus obtained was wound in a roll shape with a width of 400 mm and a length of 5000 m. The release film roll was unwound by a cutting machine at a speed of 100 m/min. An electric charge amount (unwinding electric charge amount) on the surface of the release agent layer of the just-unwound release film was measured using “Explosion-Proof Type Static Electricity Potential Measuring Device KSD-0108” made by KASUGA ELECTRIC WORKS LTD. As a result, it was found that the electric charge amount was 6 kV.

### Comparative Example 1

A release film for producing a green sheet was produced in the same manner as in Example 1 except that the base material was changed to a biaxially-stretched polyethyleneterephthalate film [having a thickness of 38 μm, an arithmetic average roughness Ra₀ of a first surface of 42 nm, a maximum projection height Rp₀ of the first surface of 619 nm, an arithmetic average roughness Ra₂ of a second surface of 42 nm, and a maximum projection height Rp₂ of the second surface of 619 nm] and that the thickness of the release agent layer was changed to 1.2 μm.

### Comparative Example 2

A release film for producing a green sheet was produced in the same manner as in Example 1 except that the base material was changed to a biaxially-stretched polyethyleneterephthalate film [having a thickness of 38 μm, an arithmetic average roughness Ra₀ of a first surface of 34 nm, a maximum projection height Rp₀ of the first surface of 250 nm, an arithmetic average roughness Ra₂ of a second surface of 7 nm, and a maximum projection height Rp₂ of the second surface of 43 nm].

These results are shown in Table 1.

The thicknesses of the release agent layers of the respective Examples and the respective Comparative Examples were measured with a reflection-type film thickness meter “F20” made by Filmetrics Co, Ltd. An arithmetic average roughness Ra₁ of an outer surface of the release agent layer, a maximum projection height Rp₁ of the outer surface of the release agent layer, the arithmetic average roughness Ra₂ of the second surface of the base material and the maximum projection height Rp₂ of the second surface of the base material were measured in the following manner. First, a double-side tape was attached to a glass plate. Then, each of the release films for producing the green sheets obtained in the respective Examples and the respective Comparative Examples was fixed to the double-side tape such that the surface opposite to the surface to be measured was positioned at a side of the glass plate. Subsequently, the arithmetic average roughnesses Ra₁ and Ra₂ and the maximum projection heights Rp₁ and Rp₂ were measured in accordance with JIS B0601-1994 using a surface roughness meter “SV3000S4” (probe type) made by Mitsutoyo Corporation.

An area occupation ratio of projections having a height of 10 nm or higher in the outer surface 121 of the release agent layer 12 was calculated from an image obtained by using an optical interference type surface profiler [made by Veeco Instruments Inc. and sold under a trade name “WYKO-1100”]. The observation was conducted in a PSI mode and at a magnification of 50. In a surface shape image in a region of 91.2 μm×119.8 μm of the obtained image, a binarization process was performed on an image of parts having the projection height of 10 nm or higher and an image of the other parts. Next, an area ratio of a region of the parts having the projection height of 10 nm or higher and a region of the other parts was calculated. The area occupation ratio of projections having the height of 10 nm or higher was obtained from the area ratio. Further, an area occupation ratio of projections having a height of 60 nm or higher in the second surface 112 of the base material 11 was calculated in the same manner as described above. Specifically, in the surface shape image, the binarization process was performed on an image of parts having the projection height of 60 nm or higher and an image of the other parts. Next, an area ratio of a region of the parts having the projection height of 60 nm or higher and a region of the other parts was calculated. The area occupation ratio of projections having the height of 60 nm or higher was obtained from the area ratio.

TABLE 1

| | Base Material | | | Release Agent Layer | | | |
|---|---|---|---|---|---|---|---|
| | Surface Roughness of Second Surface | | | | Surface Roughness of Outer Surface | | |
| | | | Area Occupation | | | | Area Occupation |
| | | | Ratio of Projections | | | | Ratio of Projections |
| | Arithmetic Average | Maximum | having Height of | | Arithmetic Average | Maximum | having Height of |
| | Roughness | Projection Height | 60 nm or higher | Thickness | Roughness | Projection Height | 10 nm or higher |
| | Ra₂ [nm] | Rp₂ [nm] | [%] | [μm] | Ra₁ [nm] | Rp₁ [nm] | [%] |
| Example 1 | 29 | 257 | 4.7 | 1 | 3 | 17 | 1.8 |
| Example 2 | 15 | 98 | 1.8 | 1 | 3 | 11 | 0.1 |
| Example 3 | 35 | 471 | 9.4 | 1 | 3 | 28 | 4.5 |
| Example 4 | 29 | 257 | 4.7 | 0.5 | 5 | 49 | 9.7 |
| Example 5 | 29 | 257 | 4.7 | 1.9 | 3 | 13 | 1.6 |
| Example 6 | 29 | 257 | 4.7 | 1 | 3 | 18 | 2.0 |
| Example 7 | 28 | 263 | 4.9 | 1 | 3 | 17 | 1.8 |
| Comparative | 42 | 619 | 10.8 | 1.2 | 4 | 38 | 5.0 |
| Example 1 | | | | | | | |
| Comparative | 7 | 43 | 0.0 | 1 | 3 | 27 | 3.8 |
| Example 2 | | | | | | | |

[2] Evaluation

The following evaluations were conducted with respect to the release films for producing the green sheets thus obtained.

[2.1] Curability Evaluation

The surface of the release agent layer of each of the release films for producing the green sheets obtained in the respective Examples and the respective Comparative Examples was reciprocatively polished ten times at a load of 1 kg/cm² using a waste cloth containing MEK. Thereafter, the surface of the release agent layer was visually observed. The curability was evaluated under the following evaluation criteria.

A: The release agent layer was not dissolved and exfoliated.

B: The release agent layer was partially dissolved.

C: The release agent layer was completely dissolved and exfoliated.

[2.2] Evaluation of Handling Ability

The handling ability of each of the release films for producing the green sheets of the respective Examples and the respective Comparative Examples wound in a roll shape was evaluated under the following evaluation criteria.

A: The sliding property of the release film for producing the green sheet was good and the air removal was good when the release film for producing the green sheet was wound in the roll shape. Moreover, the winding deviation of the release film for producing the green sheet could be prevented.

B: The sliding property of the release film for producing the green sheet was somewhat poor and the air removal was somewhat poor when the release film for producing the green sheet was wound in the roll shape. Moreover, the winding deviation of the release film for producing the green sheet was slightly generated but did not matter.

C: The sliding property of the release film for producing the green sheet was poor and the air removal was poor when the release film for producing the green sheet was wound in the roll shape. Moreover, the winding deviation of the release film for producing the green sheet was notably generated.

[2.3] Evaluation of Blocking Property

Each of the release films for producing the green sheets obtained in the respective Examples and the respective Comparative Examples was wound in a roll shape with a width of 400 mm and a length of 5000 m. The roll of the release film for producing the green sheet was stored for 30 days at a temperature of 40° C. and at a humidity of 50% or less. Thereafter, the outward appearance of the roll of the release film for producing the green sheet was visually observed. The blocking property thereof was evaluated under the following evaluation criteria.

A: The outward appearance was not changed from the time when the release film for producing the green sheet was wound in the roll shape (Blocking was not generated).

B: In the roll of the release film for producing the green sheet, there was a region where the hue was partially different (The roll tended to suffer from blocking but was still usable).

C: The hue was different over a wide region of the roll of the release film for producing the green sheet (Blocking was generated).

In case where, like the evaluation criterion C supra, the blocking is generated due to the close contact of the front and rear surfaces of the release film for producing the green sheet and the hue is different over the wide region of the roll of the release film for producing the green sheet, it is sometimes impossible to normally unwind the release film for producing the green sheet.

[2.4] Evaluation of Coatability of Slurry

135 mass parts of a mixed solvent of toluene and ethanol (having a mass ratio of 6/4) were added to 100 mass parts of barium titanate powder [BaTio₃, produced by Sakai Chemical Industrial Co., Ltd. and sold under a trade name “BT-03”], 8 mass parts of polyvinyl butyral [produced by Sekisui Chemical Co., Ltd. and sold under a trade name “S-LEC B.K BM-2”] as a binder, and 4 mass parts of dioctyl phthalate [produced by KANTO CHEMICAL CO., INC. and sold under a trade name “DIOCTYL PHTHALATE Cica GRADE 1”] as a plasticizer. A Ceramic slurry was prepared by mixing and dispersing these substances with a ball mill.

A coated layer was obtained by coating the ceramic slurry, with a die coater, on the surface of the release agent layer of each of the release films for producing the green sheets obtained in the respective Examples and the respective Comparative Examples, such that, when dried, a green sheet had a thickness of 1 μm, a width of 250 mm and a length of 10 m. A release film for producing the green sheet, provided with the green sheet was obtained by drying the coated layer at 80° C. for one minute. Thereafter, the release film for producing the green sheet, provided with the green sheet was irradiated with light of a fluorescent lamp from a side of the release film for producing the green sheet. A surface of the green sheet was visually observed. The coatability of the ceramic slurry was evaluated under the following evaluation criteria.

A: No pinhole was found in the green sheet.

B: 1 to 5 pinholes were found in the green sheet.

C: 6 or more pinholes were found in the green sheet.

[2.5] Evaluation of Releasability of Green Sheet

The green sheet formed in item [2.4] supra was released from the release film for producing the green sheet. At this time, evaluation was conducted as to whether the green sheet was normally released.

A: The green sheet was smoothly released without being broken, and the green sheet was not left on the release agent layer.

B: The green sheet was released without being broken, while somewhat lacking in smoothness, and the green sheet was not left on the release agent layer.

C: The green sheet was broken when releasing the same or the green sheet could not be released.

[2.6] Evaluation of the Number of Depressed parts 1

A coating liquid obtained by dissolving a polyvinyl butyral resin in a mixed solvent of toluene and ethanol (having a mass ratio of 6/4) was coated on the release agent layer (the outer surface of the release agent layer) of each of the release films for producing the green sheets obtained in the respective Examples and the respective Comparative Examples, such that, when dried, a polyvinyl butyral resin layer had a thickness of 3 μm. Thus, a coated layer was obtained. The polyvinyl butyral resin layer was formed by drying the coated layer at 80° C. for one minute. Subsequently, a polyester tape was attached to a surface of the polyvinyl butyral resin layer. Then, the release film for producing the green sheet was released from the polyvinyl butyral resin layer, and the polyvinyl butyral resin layer was transferred to the polyester tape. Thereafter, a surface of the polyvinyl butyral resin layer which was previously in contact with the release agent layer of the release film for producing the green sheet was observed using an optical interference type surface profiler [made by Veeco Instruments Inc. and sold under a trade name “WYKO-1100”]. The observation was conducted in a PSI mode and at a magnification of 50. The depressed parts having the shape of the release agent layer transferred thereto and having a depth of 150 nm or greater, which exist in a region of 91.2 μm×119.8 μm of the surface of the polyvinyl butyral resin layer, were counted. The number of the depressed parts was evaluated under the following evaluation criteria. In case where a capacitor was manufactured using the polyvinyl butyral resin layer (the green sheet) evaluated to be the criterion C infra, there was a tendency that short circuit was easily generated due to a decrease in breakdown voltage.

A: The number of the depressed parts was zero.

B: The number of the depressed parts was 1 to 5.

C: The number of the depressed parts was 6 or more.

[2.7] Evaluation of the Number of Depressed parts 2

A coating liquid obtained by dissolving a polyvinyl butyral resin in a mixed solvent of toluene and ethanol (having a mass ratio of 6/4) was coated on a PET film having a thickness of 50 μm such that, when dried, a polyvinyl butyral resin layer has a thickness of 3 μm. Thus, a coated layer was obtained. The polyvinyl butyral resin layer was formed by drying the coated layer at 80° C. for one minute. A laminated body was obtained by attaching each of the release films for producing the green sheets obtained in the respective Examples and the respective Comparative Examples to the polyvinyl butyral resin layer such that the second surface of the base material of the release film for producing the green sheet makes contact with the polyvinyl butyral resin layer. The laminated body was cut into a size of 100 mm×100 mm. Thereafter, the laminated body was pressed with a load of 5 kg/cm², whereby the shape of projection of the second surface of the base material of each of the release films for producing the green sheets was transferred to the polyvinyl butyral resin layer. Then, the release film for producing the green sheet was released from the polyvinyl butyral resin layer. The number of depressed parts having a depth of 500 nm or greater, which exist on a surface of the polyvinyl butyral resin layer previously kept in contact with the second surface of the base material of the release film for producing the green sheet, was counted. More specifically, the surface of the polyvinyl butyral resin layer was observed using an optical interference type surface profiler [made by Veeco Instruments Inc. and sold under a trade name “WYKO-1100”]. The observation was conducted in a PSI mode and at a magnification of 50. The depressed parts which exist in a region of 91.2 μm×119.8 μm of the surface of the polyvinyl butyral resin layer were counted. The depressed parts had the shape of the second surface transferred thereto. The number of the depressed parts was evaluated under the following evaluation criteria. In case where a capacitor was manufactured using the polyvinyl butyral resin layer (the green sheet) evaluated to be the criterion C infra, there was a tendency that short circuit was easily generated due to a decrease in breakdown voltage.

A: The number of the depressed parts was zero.

B: The number of the depressed parts was 1 to 3.

C: The number of the depressed parts was 4 or more.

The results are shown in Table 2.

TABLE 2

| | | | | Evaluation of | Evaluation of | Evaluation of | Evaluation of |
|---|---|---|---|---|---|---|---|
| | Curability | Evaluation of | Evaluation of | Coatability | Releasability of | the Number of | the Number of |
| | Evaluation | Handling Ability | Blocking Property | of Slurry | Green Sheet | Depressed parts 1 | Depressed parts 2 |
| Example 1 | A | A | A | A | A | A | A |
| Example 2 | A | B | B | A | A | A | A |
| Example 3 | A | A | A | A | A | A | B |
| Example 4 | A | A | A | A | A | A | A |
| Example 5 | A | A | A | A | A | A | A |
| Example 6 | A | A | A | A | A | A | A |
| Example 7 | A | A | A | A | A | A | A |
| Comparative | A | A | A | A | A | A | C |
| Example 1 | | | | | | | |
| Comparative | A | C | C | A | A | A | A |
| Example 2 | | | | | | | |

As is apparent in Table 2, the release film for producing the green sheet according to the present invention was superior in the coatability of the slurry, the releasability of the formed green sheet and the smoothness of the front and rear surfaces of the green sheet. Furthermore, the release film for producing the green sheet according to the present invention provided the effect of suppressing generation of the pinhole and the partial thickness variation in the green sheet. Moreover, the release film for producing the green sheet according to the present invention showed the superior handling ability during the course of winding the release film for producing the green sheet in the roll shape and was less susceptible to blocking when wound in the roll shape. In the comparative examples, however, satisfactory results were not obtained.

### INDUSTRIAL APPLICABILITY

The release film for producing the green sheet according to the present invention includes a base material having a first surface and a second surface and a release agent layer formed on the first surface of the base material. A maximum projection height Rp₂ of the second surface of the base material is in the range of 60 to 500 nm and an area occupation ratio of projections having a height of 60 nm or higher in the second surface of the base material is 10% or less. According to the present invention, it becomes possible to prevent generation of a pinhole and partial thickness variation in a green sheet. Accordingly, the present invention is industrially applicable.

### EXPLANATION OF REFERENCE NUMERAL

1: release film for producing a green sheet
11: base material
111: first surface of a base material
112: second surface of a base material
12: release agent layer
121: outer surface of a release agent layer

1. A release film for producing a green sheet, the release film comprising:
a base material having a first surface and a second surface; and
a release agent layer provided at a side of the first surface of the base material,
wherein a maximum projection height Rp₂ of the second surface of the base material is in the range of 60 to 500 nm and an area occupation ratio of projections having a height of 60 nm or higher in the second surface is 10% or less.

2. The release film of claim 1, wherein an arithmetic average roughness Ra₁ of an outer surface of the release agent layer is 8 nm or less and a maximum projection height Rp₁ of the outer surface is 50 nm or less.

3. The release film of claim 1, wherein an area occupation ratio of projections having a height of 10 nm or higher in the outer surface of the release agent layer is 10% or less.

4. The release film of claim 1, wherein an arithmetic average roughness Ra₂ of the second surface of the base material is in the range of 5 to 40 nm.

5. The release film of claim 1, wherein the base material is formed into a laminated body having laminated layers, and at least one of the laminated layers is an antistatic layer.

6. The release film of claim 2, wherein an area occupation ratio of projections having a height of 10 nm or higher in the outer surface of the release agent layer is 10% or less.

7. The release film of claim 2, wherein an arithmetic average roughness Ra₂ of the second surface of the base material is in the range of 5 to 40 nm.

8. The release film of claim 3, wherein an arithmetic average roughness Ra₂ of the second surface of the base material is in the range of 5 to 40 nm.

9. The release film of claim 6, wherein an arithmetic average roughness Ra₂ of the second surface of the base material is in the range of 5 to 40 nm.

10. The release film of claim 2, wherein the base material is formed into a laminated body having laminated layers, and at least one of the laminated layers is an antistatic layer.

11. The release film of claim 3, wherein the base material is formed into a laminated body having laminated layers, and at least one of the laminated layers is an antistatic layer.

12. The release film of claim 4, wherein the base material is formed into a laminated body having laminated layers, and at least one of the laminated layers is an antistatic layer.

13. The release film of claim 6, wherein the base material is formed into a laminated body having laminated layers, and at least one of the laminated layers is an antistatic layer.

14. The release film of claim 9, wherein the base material is formed into a laminated body having laminated layers, and at least one of the laminated layers is an antistatic layer.

15. The release film of claim 7, wherein the base material is formed into a laminated body having laminated layers, and at least one of the laminated layers is an antistatic layer.

16. The release film of claim 8, wherein the base material is formed into a laminated body having laminated layers, and at least one of the laminated layers is an antistatic layer.
